(19) United States
(12) Patent Application Publication
(10) Pub. No.: US 2013/0146104 A1
(43) Pub. Date: Jun. 13, 2013

(54) Method For Cleaning The Usable Space Of A Climatic Cabinet

(71) Applicant: Thermo Electron LED GmbH, Langenselbold (DE)

(72) Inventor: Hermann Stahl, Nidderau-Ostheim (DE)

(73) Assignee: Thermo Electron LED GmbH, Langenselbold (DE)

(21) Appl. No.: 13/711,849

(22) Filed: Dec. 12, 2012

(30) Foreign Application Priority Data
Dec. 13, 2011 (DE) 10 2011 121 019.2

(51) Int. Cl. B08B 3/00

(52) U.S. Cl. CPC B08B 3/00
USPC 134/31

(57) ABSTRACT

The present invention relates to a method for cleaning a usable space of a climatic cabinet, said usable space being surrounded by walls and optionally being provided with fittings, in which steam is generated by heating a water reservoir while at the same time steam is caused to condense on said walls and on any fittings present in the usable space.

### CROSS-REFERENCE TO RELATED APPLICATIONS

The present application claims priority under 35 U.S.C. §119 of German Patent Application No. 10 2011 121 019.2, filed Dec. 13, 2011, the disclosure of which is hereby incorporated herein by reference in its entirety.

### FIELD OF THE INVENTION

The present invention relates to a method for cleaning a usable space of a laboratory climatic cabinet. Climatic cabinets in laboratories usually serve the purpose of storing biological or microbiological samples under specific conditions, such as a defined temperature and defined air humidity and—in the case of gassed incubators—a defined gas atmosphere, in the incubator's interior—hereinafter referred to as the “usable space”. During operation, the usable space becomes contaminated, and this necessitates disinfection thereof at certain time intervals. The purpose of such disinfection is to kill germs present in the usable space, such as bacteria or spores.

### BACKGROUND OF THE INVENTION

In the prior art, a disinfecting method is known in which dry, hot air having, for example, a temperature of 140° C. is passed into the usable space, where it kills the germs. Another method of disinfection is described in EP 0 923 946 B1. In this multiple-stage method, steam having a temperature of 90° C. is used instead of dry hot air for the purpose of killing the germs. For the purpose of generating steam, a water reservoir located on the floor of the usable space is heated by means of heating elements disposed underneath the floor of the usable space. At the same time, all of the heating elements employed for heating the walls surrounding the usable space are operated, in order to achieve a maximum air humidity of more than 80% in the usable space. This highly moist internal atmosphere is maintained for a period of approximately 9 hours. Then all of the heating elements are switched off, in order to cause the steam to condense out of the usable space. In the cooling phase, the condensate re-accumulates in the floor area, that is to say, in the region of the water reservoir, while any condensation on the walls and the inside door of the climatic cabinet is to be prevented. Normal operation is then resumed.

The drawback of the aforementioned method of disinfection is that the killed germs remain in the interior of the climatic cabinet. These impurities adhere, for example, to the walls and fittings pertaining to the usable space. When it is desired to remove these impurities, the said regions must be laboriously cleaned by hand.

### SUMMARY OF THE INVENTION

It is thus an object of the present invention to provide a method for cleaning a usable space of a laboratory climatic cabinet which obviates the need to remove adhering impurities by hand.

In the cleaning method of the present invention, steam is produced by heating a water reservoir while at the same time steam is caused to condense in the usable space. The purpose of the method of the present invention is to generate steam to a massive extent and to cause it to condense, in large quantities, in the usable space, more specifically on the walls surrounding, and any fittings present in, the usable space of the laboratory climatic cabinet, such that the hot steam can loosen and wash away the impurities adhering to said walls and to said fittings, such as sample holders, measuring devices, etc., and entrain such impurities to the water reservoir, from which they can be removed from the climatic cabinet. The present invention therefore utilizes the hot steam for the purpose of loosening the impurities adhering to the usable space and thus obviates the need for removal thereof by hand. Loosening with hot steam has the additional advantage that the steam reaches difficultly accessible regions that are virtually impossible to clean by hand. The generation of steam can be carried out by repeated or continuous heating of the water in the water reservoir. Preferably, steam is continuously generated and caused to condense, advantageously until the impurities have been removed as completely as possible from the walls and fittings pertaining to the usable space. The period of time necessary for this procedure depends on the type of climatic cabinet and on the degree of contamination, but can be readily ascertained by routine testing.

The difference between the cleaning method of the present invention and the method of disinfection described in EP 0 923 946 B1 primarily consists in that steam is deliberately condensed to a massive extent on the walls and fittings in the usable space. To this end, steam is advantageously constantly regenerated during the process of condensation, for example, by continued heating of the water reservoir. By contrast, although steam is produced in the method according to EP '946 during its disinfecting phase, this step does not serve the purpose of cleaning the usable space but only of achieving disinfection by killing the germs. For this purpose, steam is kept at 90° C. in the usable space in as high a concentration as possible. To this end, all of the heating elements are switched on, not only in the floor area, but also on the walls. Condensation of steam does not therefore take place during this disinfecting phase. During the subsequent condensation phase, which serves to reduce the steam concentration in the usable space, the condensation of water on the walls and on the inside door that closes the usable space should likewise be avoided as far as possible. Rather, condensation should take place only in the floor region of the usable space. Thus, during the condensation phase, no heating of the water reservoir with generation of more steam takes place, contrary to the method of the present invention.

Also, in the case of the method of the present invention, it is possible for the usable space to be surrounded by walls that are adapted to be heated by at least one heating device. This heating device is, however, only provided for normal operation and is thus not switched on during the cleaning operation to ensure that adequate condensation of water can take place. In order to assist the condensation of water on the walls, provision may even be made, within the scope of the present invention, for the walls that surround the usable space to be cooled during the cleaning process. If the climatic cabinet is, for example, one which has double walls, a simple variant may comprise passing cold air into the gap between the walls so as to cool the walls surrounding the usable space. Alternatively, there may be provided at least one cooling means extending along the external surface of the usable space walls. For example, Peltier elements or cooling pipes can be provided for this purpose. Alternatively, a heating device provided for normal operation can be used as cooling means during the cleaning operation, for example, in that a coolant is passed through the pipes instead of heating fluid.

The water reservoir used for the generation of steam during the cleaning process, can, in one embodiment, be located in the interior of the usable space. For example, a floor pan can be placed in known manner in the usable space or, as described in EP '946, the encasement surrounding the usable space can serve directly as accommodation for the water bath. In another and at present preferred variant, the water reservoir is disposed outside the climatic cabinet, and steam is externally fed to the usable space. This possibility has the advantage that the steam can be introduced in a higher concentration than when heating a water bath disposed in the interior of the usable space. Moreover, the walls are heated to a lesser extent, which improves condensation in these regions. Generation of the steam can be carried out, for example, in known manner in an autoclave or superheated steam generator. Preferably, the input of steam takes place in the manner already described by the applicant in the prior applications DE 10 2011 111 754.0 and DE 10 2011 114 900.0, although for a different purpose. The cleaning method of the present invention has the overall advantage that it can be readily carried out on prior art climatic cabinets without much need for retrofitting. This considerably facilitates the application of the method of the present invention. It is particularly preferred to input the steam into the usable space in all described variants under normal pressure or under a very small excess pressure of maximally 0.5 bar, usually of less than 0.2 bar. In order to prevent the development of a higher pressure in the usable space, the latter can be provided with, say, a pressure equalizing valve or any comparable pressure equalizing means.

Another advantage of the present invention consists in that the impurities loosened by the cleaning method of the present invention from the walls and fittings in the usable space can be very simply removed from the usable space. Following execution of the cleaning method, the impurities are dissolved in the condensed steam or are present on the floor of the usable space in a washed out state in the condensed water. Here, they can be either removed with the condensed water by hand or—preferably—drained off from the interior of the usable space through a drain disposed in the region of the floor of the usable space where the contaminated water collects. It is particularly preferred to collect the contaminated water in a receptacle. Preferably, a disposable receptacle is used for this purpose, so that the user of the climatic cabinet keeps out of contact with the contaminated water as far as possible.

Even though a certain degree of disinfection may result from the cleaning process of the present invention by reason of the hot steam generated, the main aim of the method is to loosen impurities from the walls and fittings in the usable space. It is thus preferable to carry out the method of the present invention in combination with a sterilization step. This sterilization step serves the specific purpose of killing germs in the interior of the usable space to a maximum extent. For this purpose, use can be made of any prior sterilization process. For example, a moist disinfection step carried out at 90° C. can be used, as described in EP '946. However, this disinfection step is not followed by the condensation and cooling steps disclosed in EP '946, but by the cleaning method as described above. However, it is preferred to employ sterilization using dry hot air advantageously having a temperature of at least 140° C. and preferable of approximately 180° C., in combination with the cleaning method of the present invention. Such dry sterilization has the advantage that it also reliably kills spores.

The order of the method steps can be such that first of all a sterilization step is carried out, this being followed by the cleaning method of the present invention. This then removes the germs killed during the sterilization step from the usable space. If desired, the cleaning method of the present invention can be followed by another sterilization step, in order to improve the sterility of the usable space still further, for subsequent normal use thereof. Alternatively, it is possible to carry out the cleaning method of the present invention first and then the sterilization step, more particularly, a dry sterilization step. Since cleaning usually takes a number of hours for completion, it is preferred, in order not to have an unduly negative influence on normal operation, to leave it to the user to decide when he or she would start this procedure. It is, however, possible to provide, at specific intervals, some indication of the fact that a cleaning step is due. Basically, it is likewise possible to initiate the cleaning operation via the control system for the climatic cabinet automatically. On conclusion of the cleaning procedure, there may be emitted, for example, an optical or acoustic signal indicating that the water reservoir containing the impurities is due to be removed from the usable space.

### BRIEF DESCRIPTION OF THE DRAWINGS

The present invention is explained in more detail below with reference to the drawings comprising schematic, unscaled figures:

FIG. 1 shows a cross-section of a climatic cabinet for carrying out the method of the present invention;

FIG. 2 shows a cross-section of a climatic cabinet connected to an external steam generator for carrying out the method of the present invention; and

FIG. 3 shows a cross-section of another climatic cabinet connected to a different external steam generator for carrying out the method of the present invention.

### DETAILED DESCRIPTION OF THE INVENTION

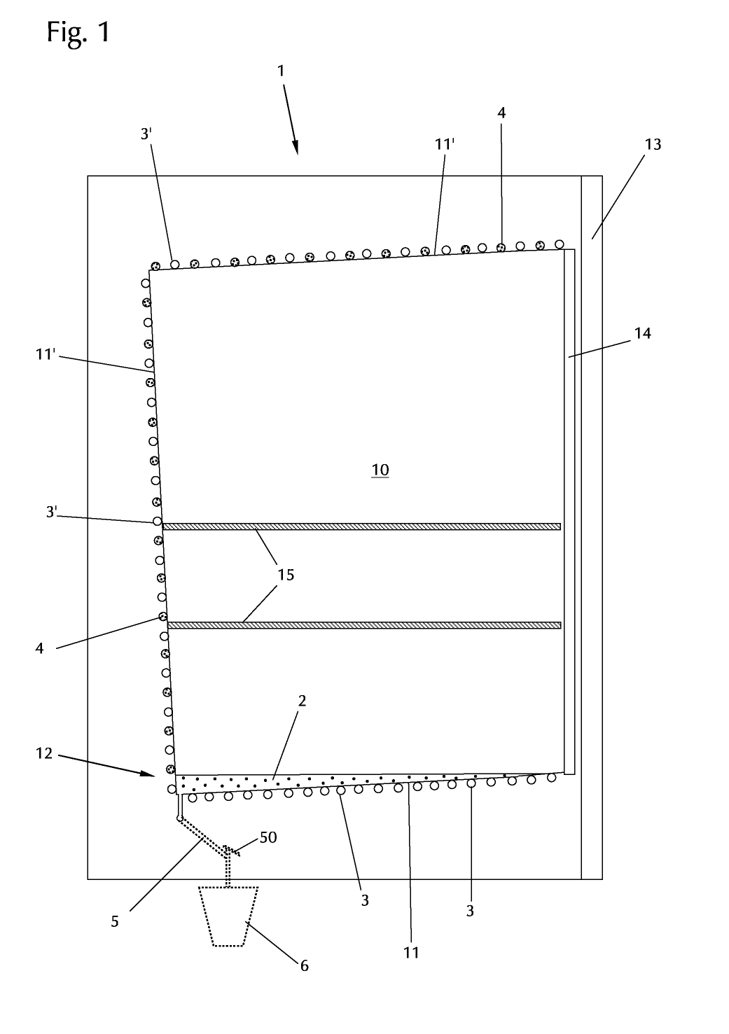

FIG. 1 shows a laboratory climatic cabinet, for example, a gassed or CO₂ incubator, as is basically already known from EP '946. In the interior of the climatic cabinet 1, which is accessible via a door 13, there is a usable space 10, which is delimited by a floor plate 11 and walls 11′. The usable space 10 is additionally sealed off by an inside door 14 disposed behind the outer door 13. The walls 11′ surrounding the usable space 10 and the floor plate 11 form a container that slopes downwardly away from the inside door 14. Thus, the floor plate 11 of said container slopes downwardly away from the inside door 14. A water reservoir is disposed in the sink thus formed in the floor area 12. The water reservoir 2 can be heated with the aid of a heating device 3, here in the form of heating pipes placed underneath the floor plate 11, in order to cause evaporation of the water in the water reservoir. Heating devices 3′ are likewise disposed in the region of the side walls, the rear wall, and the ceiling 11′, which are not visible in the cross-sectional view. These heating devices 3′ serve, during normal operation of the climatic cabinet, to prevent water from condensing in the region of the walls 11′. In addition, the inside door 14 itself is preferably heated during normal operation of the climatic cabinet, for example, by means of a foil heating system (not shown). In the interior of the usable space 10, there are present a plurality of sample holders 15 for the purpose of storing biological or microbiological samples or the like. In addition, fittings in the usable space, such as measuring devices, etc., are not shown for the sake of clarity.

In order to execute the cleaning method of the present invention, normal operation is stopped. All of the samples are removed from the usable space 10. Preferably, a sterilization step is first carried out, which may consist, for example, in the introduction of dry hot air. Then the cleaning operation is started. The entire procedure is monitored and controlled by means of the control system for the climatic cabinet 1. When carrying out the cleaning operation, the heating devices 3 in the region of the floor plate 11 underneath the water reservoir 2 are put into operation. However, the heating devices 3′ in the region of the side walls and ceiling 11′ remain switched off. Unlike the conditions prevailing during normal operation, the side walls and ceiling 11′ are thus comparatively cold. Operation of the heating device 3 in the floor area 12 causes water to be evaporated from the water reservoir 2, and the resulting steam flows into the usable space 10. This steam is caused to condense on the side walls and ceiling surrounding the usable space 10. The condensed water flows off the ceiling and side walls 11′ back to the floor area 12 and thus back into the water reservoir 2. Impurities loosened by the heated steam are thus washed away from the walls, the sample holders 15, and other internal fittings present in the usable space 10 but not shown in FIGS. 1-3 and accumulate in the water reservoir 2. The heating device 3 in the floor area 12 of the climatic cabinet 1 is operated throughout the entire cleaning procedure, so that water is continuously evaporated from the water reservoir 2 and condenses on the cool side walls and ceiling and flows back into the water reservoir 2. Depending on the degree of contamination of the usable space 10, this procedure is continued until substantially all of the impurities deposited on the walls and equipment pertaining to the usable space 10 have been removed. It is preferred to let the cleaning procedure run overnight.

In order to assist condensation on the side walls and ceiling 11′, cooling means 4 are provided, in the embodiment shown, in the region of the side walls and ceiling 11′. This cooling means 4 are in this case in the form of cooling pipes extending along the external surfaces of the walls 11′ surrounding the usable space 10. However, no cooling means 4 are present underneath the floor plate 11. Cooling of the side walls and ceiling 11′ causes improved condensation and quicker recirculation to the water reservoir 2 of the evaporated water that has been caused to condense on the walls 11′.

On conclusion of the evaporation and condensation process and a cooling period, the water containing the impurities is removed from the floor area 12 of the climatic cabinet 1. In a simple variant of the present invention, this can take place by wiping the water reservoir in the usable space 10 clean by reaching through the opened doors 13 and 14. However, it is preferred to drain the water through an outlet 5 out of the usable space. In the case shown, the outlet 5 is located in a rearward region remote from the doors 13 and 14 and situated at the lowest point of the floor of the usable space. The contaminated water is passed through the outlet 5 and flows laterally out of the climatic cabinet 1 to the outside. The parts of the outlet and receptacle 6 that are situated outside the illustrated cross-sectional plane are indicated in FIG. 1 by dotted lines. The contaminated water flows from the outlet 5, which can be closed by a faucet 50, directly into a disposable receptacle 6. This disposable receptacle 6 can be, for example, a cup filled with cotton wool and made of recycled plastics material such that it can be disposed of with the normal garbage without the user coming into contact with its contents.

On conclusion of the cleaning procedure, normal operation can be resumed, possibly following the execution of an additional sterilization step.

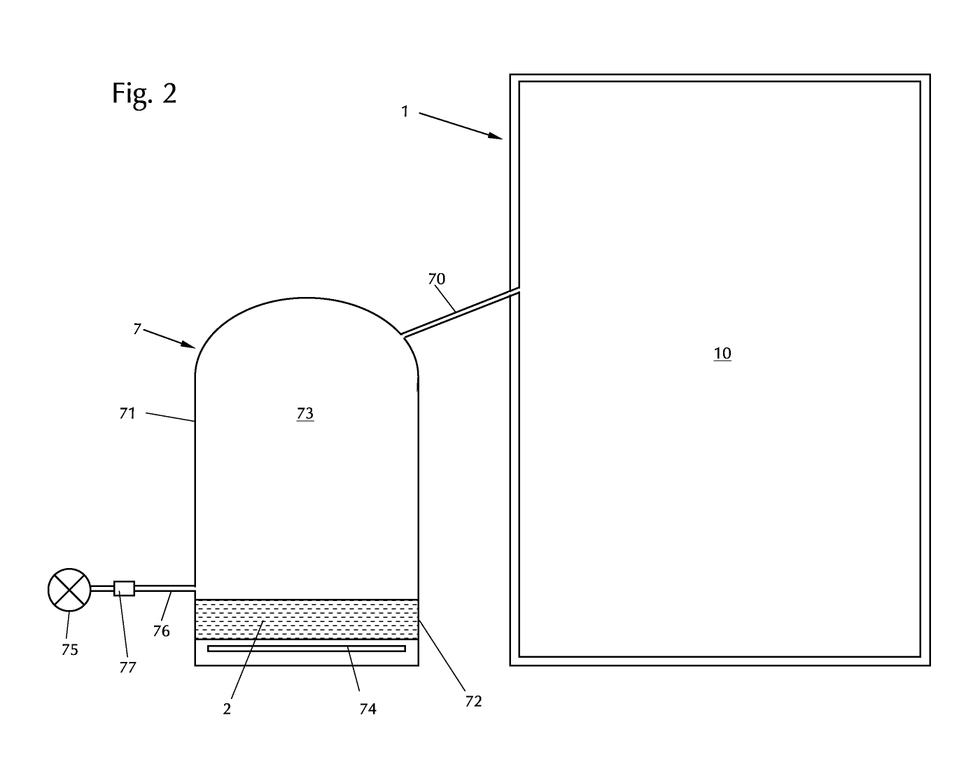

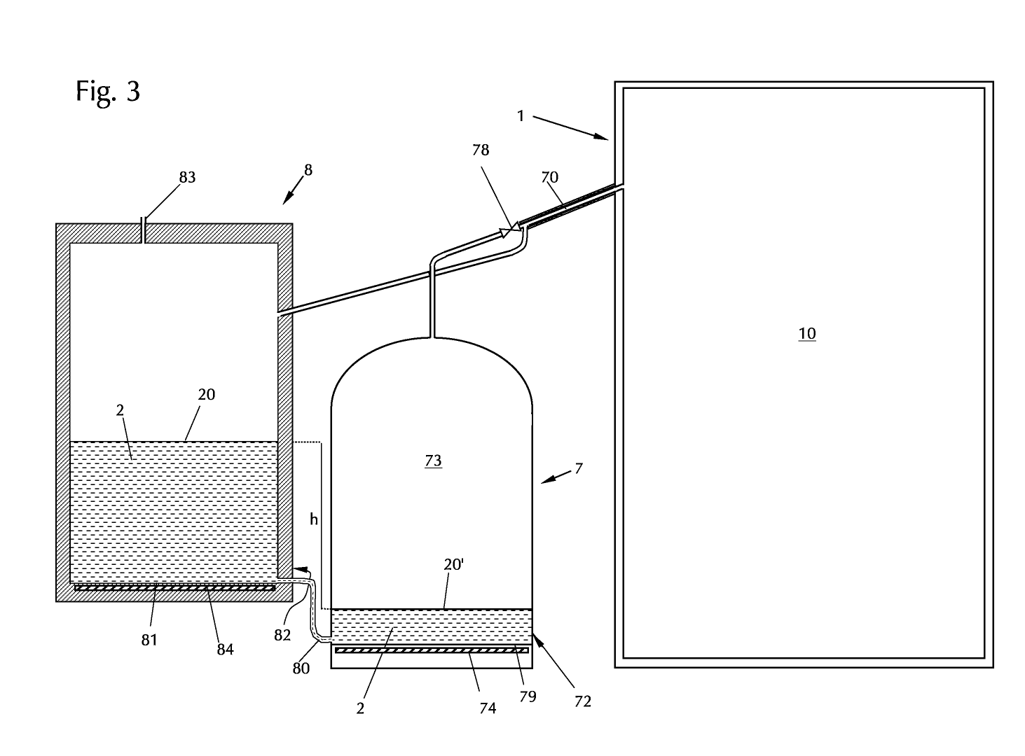

FIGS. 2 and 3 depict the present invention with reference to gassed climatic cabinets (incubators) 1 equipped with external steam generators 7 by way of example. The climatic cabinet 1 can be basically set up as described with reference to FIG. 1. The details are omitted here for the sake of clarity. Moreover, the procedure is basically the same as that described above and differs therefrom only as regards the type of steam generation used. Instead of the evaporation of water in the interior of the usable space 10, steam is fed to the latter externally.

In the embodiment shown in FIG. 2, an external steam generator 7 is connected by a steam supply pipe 70 to the usable space 10 of the climatic cabinet 1. The steam generator 7 consists of a tank 71 comprising a floor area 72 capable of accommodating a water reservoir 2 and situated below a steam chamber 73, which is in this case dome-shaped. The tank 71 is an unpressurized tank, in which steam generated by heating the water reservoir 2 by means of a heating device 74 is not compressed in the steam generator 7, so that its vapor pressure is substantially equal to the ambient pressure and is certainly not more than 0.5 bar and usually less than 0.2 bar.

The steam present in the steam chamber 73 is fed to the climatic cabinet 1 in that air is conveyed by a pump 75 from the environment of the steam generator 7 through the air inlet pipe 76 into the interior of the steam generator 7. In the embodiment shown, said air inlet pipe 76 is attached to the steam chamber 73 at a level above the water reservoir 2. Alternatively, the air inlet pipe can be at a lower level, such that the ambient air passes into the steam chamber 73 through the water reservoir 2. While passing through the steam generator, the ambient air becomes enriched with steam and flows through the steam supply pipe 70 into the usable space 10 of the climatic cabinet. To ensure that no impurities are transported with the ambient air into the steam generator 7, a sterile filter 77 is interposed between the pump 75 and the steam generator 7 in the air inlet pipe 76.

FIG. 3 shows a steam generator 7, which likewise consists of a tank capable of accommodating a water reservoir 2 in a floor area 72. Steam is generated in said generator 7 by heating the water reservoir 2 by means of a heating device 74. The steam passes via a steam supply pipe 70 into the steam chamber 73 and thence to the usable space 10 in the climatic cabinet 1, leaving the steam generator 73 at the highest point thereof. The steam supply pipe 70 can be closed by means of a valve 78, which is opened in known manner when steam is to be fed to the usable space 10 for cleaning purposes.

The steam generator 7 is connected to a water tank 8 via a water inlet pipe 80 leading from its floor area 72 and disposed such that the base plate 79 supporting the water bath 2 in the steam generator 7 is at a level below the corresponding base plate 81 in the water tank 8. The water inlet pipe 80 leads from a floor area 82 of the water tank 8. The water reservoir 2 is thus spread over the steam generator 7 and the water tank 8. When the water reservoir 2 in the steam generator is heated by the heating device 74 preferably to a temperature of approximately 100° C., steam is formed that then fills up the steam chamber 73. By this means, there is caused a pressure increase in the steam generator 7 and the water level 20′ drops, and water is forced out of the steam generator 7 through the water inlet pipe 80 into the water tank 8. The water level 20 therein rises. This is illustrated in FIG. 3, that is, it shows a state during the generation of steam in the steam generator 7. The vapor pressure in the steam generator 7 is equal to the water column above the water level 20′, that is to say, to the difference between the water levels 20 and 20′ (height h).

The arrangement of the water tank 8 relative to the steam generator 7 is such that under normal circumstances the water in the water inlet pipe 80 is not completely displaced out of the pipe. Any steam passing into the water inlet pipe 80 comes into contact with the colder water in the pipe 80, cools down, and condenses, thus causing a drop in pressure. In order to compensate for unduly high excess pressure, the water tank 8 is additionally provided with a breather 83, through which any steam that might pass into the water tank 8 can escape. The occurrence of steam explosions is in this way reliably prevented. Basically, the water reservoir 2 in the water tank 8 need requires no heating, but in the embodiment shown a heating device 84 is provided, by means of which the water reservoir 2 in the water tank 8 can be heated, if desired, albeit to a lower temperature than in the steam generator 7. Preferably, it is heated to a temperature of at least 60° C., more preferably to from 80° to 90° C. The higher the temperature of the water reservoir 2, the smaller the probability of germs being formed in the water and the lower the heating energy required for bringing the water in the steam generator 7 to the boil. However, the temperature of the water reservoir 2 in the water tank 8 should not be so high that the water therein begins to boil.

While the present invention has been illustrated by description of various embodiments and while those embodiments have been described in considerable detail, it is not the intention of Applicant to restrict or in any way limit the scope of the appended claims to such details. Additional advantages and modifications will readily appear to those skilled in the art. The invention in its broader aspects is therefore not limited to the specific details and illustrative examples shown and described. Accordingly, departures may be made from such details without departing from the spirit or scope of Applicant's invention.

What is claimed is:

1. A method for cleaning a usable space of a climatic cabinet during a cleaning procedure, said usable space being surrounded by walls, comprising the steps of:
generating steam by heating a water reservoir while at the same time condensing steam on said walls of said usable space.

2. The method as recited in claim 1, wherein said usable space is surrounded by walls that are adapted to be heated by means of at least one heating device, the method further comprising the step of switching off the heating device during the cleaning procedure.

3. The method as recited in claim 1, further comprising the step of cooling said walls during the cleaning procedure by means of at least one cooling means.

4. The method as recited in claim 1, wherein said water reservoir is disposed in a floor area within said usable space.

5. The method as recited in claim 1, wherein said water reservoir is located outside said climatic cabinet and said steam is passed into said usable space.

6. The method as recited in claim 1, wherein said steam is generated in said usable space at a pressure of maximally 0.5 bar, preferably less than 0.2 bar.

7. The method as recited in claim 1, wherein, on conclusion of the cleaning procedure, condensed water is collected in a floor area of said usable space and then removed from said usable space.

8. The method as recited in claim 7, wherein the condensed water is drained off via an outlet.

9. The method as recited in claim 1, further comprising a sterilization step.

10. The method as recited in claim 9, wherein said sterilization step takes place after said cleaning step.

11. The method as recited in claim 1, wherein said usable space is provided with fittings, the method further comprising the step of condensing said steam on said fittings.

12. The method as recited in claim 8, wherein the condensed water is collected in a disposable receptacle.

13. The method as recited in claim 9, wherein the sterilization step comprises blowing hot air into said usable space.

14. The method as recited in claim 9, wherein said sterilization step is carried out both prior to and following said cleaning step.
